(19) United States
(12) Patent Application Publication
(10) Pub. No.: US 2026/0260219 A1
(43) Pub. Date: Sep. 3, 2026

(54) METHOD AND DEVICE FOR AIDING A MAINTENANCE DECISION CONCERNING AN APPARATUS SUCH AS AN AIRCRAFT, AND CORRESPONDING METHOD FOR CONSTRUCTING A MODEL AND MAINTENANCE METHOD

(71) Applicant: AIRBUS SAS, Blagnac (FR)

(72) Inventor: Bernard ORDY, Blagnac (FR)

(73) Assignee: AIRBUS SAS, Blagnac (FR)

(21) Appl. No.: 19/311,724

(22) Filed: Aug. 27, 2025

(30) Foreign Application Priority Data
Aug. 29, 2024 (FR) 2409218

(51) Int. Cl. G06Q 10/20; G06F 30/15

(52) U.S. Cl. CPC G06Q 10/20

(57) ABSTRACT

A method for aiding a maintenance decision in relation to an apparatus, such as an aircraft, where a technical failure is detected and entered in a logbook, the resulting entry being referred to as an entry to be processed. The method receives the entry to be processed; queries a model; and provides a user with a result provided by the model and has a list of responses associated with a group of entries selected by the model due to the fact it has entries having a meaning that is identical or similar, in terms of describing a technical failure, to the meaning of the entry to be processed. By virtue of this list, the user is able to quickly and effectively respond to the entry to be processed. A method for constructing the model from data (entries and responses) collected in logbooks of a fleet of apparatuses.

### TECHNICAL FIELD

The field of the invention is that of the maintenance of apparatuses, in particular but not exclusively of aircraft.

More precisely, the present invention relates to a method for aiding a maintenance decision in relation to an apparatus on which a technical failure is detected and entered in a logbook of the apparatus.

The present invention also relates to an assistance device, as well as a computer program product and a storage medium for implementing such a method for aiding a maintenance decision.

The present invention also relates to a method for constructing a model configured to be used in the abovementioned method for aiding a maintenance decision.

The present invention also relates to a maintenance method using the abovementioned method for aiding a maintenance decision.

The present invention is not limited to aircraft, but is also applicable to many other apparatuses (vehicles, machines, devices, equipment, etc.) requiring maintenance and for which there is a logbook containing entries (recording technical failures detected on the apparatus) and corresponding responses (recording maintenance procedures that made it possible to address these failures).

### PRIOR ART

A presentation will now be given of the prior art in the case of aircraft maintenance. This discussion may easily be transposed to the maintenance of other types of apparatus.

All maintenance operations carried out on an aircraft (new parts added, date of inspection, etc.) are recorded in a logbook in an organized and defined form. When an entry (also called a “logbook complaint”) is made in the logbook by pilots, on-board staff or mechanics, the following flight is authorized only when a corresponding response is recorded and after this response has been accepted by the crew that will carry out this following flight. Each entry in the logbook of an aircraft relates to a technical failure detected on this aircraft (alarm, anomaly or other event observed by the crew in flight or on the ground), and the associated response indicates a maintenance procedure (also called a “repair procedure” or “troubleshooting procedure”) that made it possible to address this technical failure.

The standard procedure for responding to an entry in the logbook is to use the data available on the aircraft (for example the post-flight report, PFR) and the details of the entry in the logbook so that a maintenance operator (mechanic) is able to start the diagnostic procedure. The diagnostic procedure is guided by the troubleshooting manual (TSM) in order to isolate the cause of the fault and link it to an appropriate maintenance (repair) procedure. Maintenance procedures are available in the aircraft maintenance manual (AMM). The TSM and AMM manuals, which were originally in paper format, are nowadays in the form of electronic documents through which the maintenance operator is able to navigate freely using hyperlinks. Similarly, the logbook, which was originally in paper format, is nowadays in the form of an electronic document called an “eLogbook”. It may also be the case that the paper logbook is digitized manually, by virtue of operators transcribing the contents thereof, or else digitized automatically (for example using a scanner and character recognition software).

The abovementioned standard procedure for responding to an entry in the logbook is satisfactory, but there is a need to improve it further. Indeed, for the maintenance operator, who often intervenes during the turnaround time (TAT) of the aircraft, it may be time-consuming and require a number of attempts to identify the correct maintenance procedure. This is because the troubleshooting procedure (based on the TSM manual) and the associated tests (based on the AMM manual) may require a great deal of time. Moreover, closing this entry (logbook complaint) may require a number of attempts to identify the right procedure to correct the anomaly reported in this entry. In other words, in the standard procedure, the mechanic, in order to identify the maintenance action that will make it possible to solve the anomaly reported in the logbook entry (logbook complaint), must use the TSM manual, which asks them to carry out a number of maintenance actions (described in the AMM manual) before arriving at the final resolution action, which is also described in the AMM manual.

### SUMMARY OF THE INVENTION

What is proposed is a method, implemented by an assistance device comprising electronic circuitry, for aiding a maintenance decision in relation to an apparatus on which a technical failure is detected and entered, as an entry (501) to be processed, in a logbook of the apparatus, the method comprising:
receiving the entry to be processed (logbook complaint);
querying, with the entry to be processed, a model that is configured to provide, when it is queried with a given entry, a result comprising a list of responses that is associated with a group of entries that is selected from a plurality of groups of entries, each group of entries being formed from entries contained in collected data and having a common meaning in terms of describing a technical failure, each group of entries being associated with a list of responses that is generated from the responses associated with the entries in said group of entries, the selected group of entries comprising entries having a meaning that is identical or similar, in terms of describing a technical failure, to the meaning of the given entry, the collected data originating from logbooks of a fleet of apparatuses and comprising entries relating to technical failures detected on the apparatuses of the fleet and associated responses indicating the maintenance procedures that made it possible to address said technical failures; and
providing a user with the result of querying the model with the entry to be processed, the result comprising the list of responses that is associated with the group of entries that is selected by the model according to the entry to be processed.

The proposed solution thus makes it possible to help a user easily and quickly choose the most relevant and efficient maintenance procedure (action), and therefore thus quickly and effectively respond to an entry in the logbook of an apparatus (such as an aircraft). It uses a model that is based on data collected in logbooks of a fleet of apparatuses and comprises entries and associated responses. Indeed, considering that all apparatuses of this fleet are flying or are technically ready to fly, it is possible to conclude therefrom that all entries in the logbooks of these apparatuses have received an effective response that has been accepted by the pilots. When the model is queried with a (logbook) entry to be processed, it provides a result comprising a list of responses that are associated with entries having a meaning that is identical or similar, in terms of describing a technical failure, to the meaning of the entry to be processed. In other words, by using millions of logbook entries and the corresponding responses, the proposed solution makes it possible to effectively guide the user (for example a maintenance operator) by listing responses to them that have already been provided in the past (for other apparatuses, in response to identical or similar entries).

According to one particular embodiment, the apparatus is an aircraft.

According to one particular embodiment, the list of responses that is associated with the selected group of entries comprises references belonging to the group comprising:
aircraft maintenance manual references, referred to as AMM references; and
master minimum equipment list references, referred to as MMEL references.

The user is thus easily able to understand the list of responses (one or more AMM references and/or one or more MMEL references) provided by carrying out the method. It will be recalled that the MMEL is a categorized list of on-board systems, instruments and equipment that may be inoperative for a limited number of flights for a specified aircraft model.

According to one particular embodiment, each of the responses contained in the list of responses that is associated with the selected group of entries is associated with effectiveness information.

The user is thus easily able to compare the responses contained in the list of responses that is provided by carrying out the method.

According to one particular embodiment, the responses contained in the list of responses that is associated with the selected group of entries are sorted according to the effectiveness information associated with said responses.

The user is thus more easily able to choose a response from the list of responses that is provided by carrying out the method.

According to one particular embodiment, the effectiveness information associated with a given response depends on at least one parameter belonging to the group comprising:
a number of occurrences of the given response in the data collected by the model; and
a period of time for which no new occurrence of the given response appears in the data collected by the model.

The effectiveness information is thereby calculated in a simple and relevant manner.

According to one particular embodiment, the list of responses that is associated with the selected group of entries comprises:
a first sub-list, referred to as a repair sub-list, containing responses that each made it possible to avoid any new occurrence of the associated entry at least for a predetermined reference period; and
a second sub-list, referred to as a release sub-list, containing responses that each made it possible to avoid any new occurrence of the associated entry only for a period shorter than the predetermined reference period.

This further increases the quantity of information provided to the user in order to compare the responses contained in the list of responses that is provided by carrying out the method.

According to one particular embodiment, the result of the querying of the model with the entry to be processed furthermore comprises at least one possible operational impact indicator.

This further increases the quantity of information provided to the user in order to compare the responses contained in the list of responses that is provided by carrying out the method.

According to one particular embodiment, said at least one possible operational impact indicator belongs to the group comprising:
an aircraft delay above a predetermined threshold indicator;
an aircraft flight cancellation indicator;
an aircraft returning to point of departure indicator; and
an aircraft change of destination indicator.

According to one particular embodiment, said at least one possible operational impact indicator has a value that depends on possible operational impact values obtained beforehand for at least some of the responses in the list of responses that is associated with the selected group of entries.

According to one particular embodiment, the method furthermore comprises:
receiving a response selected by the user from the list of responses that is associated with the selected group of entries; and
adding the selected response to the data collected and processed by the model, associating the selected response with the entry to be processed.

The collected data thus continue to be enriched, and the effectiveness of the model therefore continues to be improved.

What is also proposed is a computer program product comprising instructions that cause a processor to carry out the abovementioned method for aiding a maintenance decision according to any one of its embodiments when said instructions are executed by the processor.

What is also proposed is a storage medium storing such instructions.

What is also proposed is an assistance device comprising electronic circuitry configured to implement the abovementioned method for aiding a maintenance decision according to any one of its embodiments.

What is also proposed is a computer-implemented method for constructing a model configured to be used in an abovementioned method, according to any one of its embodiments, for aiding a maintenance decision in relation to an apparatus on which a technical failure is detected and entered in a logbook of the apparatus, the resulting entry being referred to as an entry to be processed, the method for constructing the model comprising:
receiving data collected in logbooks of a fleet of apparatuses and comprising entries and associated responses, each entry relating to a given technical failure detected on one of the apparatuses of the fleet of apparatuses, and being associated with a response indicating a maintenance procedure that made it possible to address the given technical failure;
forming groups of entries from the entries contained in the collected data, entries in one and the same group having a common meaning in terms of describing a technical failure;
associating, with each group of entries, a list of responses that is generated from the responses associated with the entries in said group of entries; and
learning to provide, when the model is queried with a given entry to be processed, a result comprising a list of responses that is associated with a group of entries that is selected from the plurality of groups of entries, the selected group of entries comprising entries having a meaning that is identical or similar, in terms of describing a technical failure, to the meaning of the given entry to be processed.

Thus, the greater the quantity of data collected and processed, the more effective the constructed model (that is to say the more relevant the list of responses that is provided by the model when carrying out the abovementioned method for aiding a maintenance decision).

What is also proposed is a method for maintaining an apparatus on which a technical failure is detected and entered in a logbook of the apparatus, the resulting entry being referred to as an entry to be processed, the maintenance method comprising:
carrying out the abovementioned method for aiding a maintenance decision, according to any one of its embodiments, the aiding method receiving the entry to be processed and providing a result comprising a list of responses that is associated with a group of entries that is selected according to the entry to be processed;
choosing a response from the list of responses; and
carrying out a maintenance procedure indicated in the chosen response.

### BRIEF DESCRIPTION OF THE DRAWINGS

The abovementioned features of the invention, along with others, will become more clearly apparent upon reading the following description of at least one exemplary embodiment, said description being given with reference to the appended drawings, in which:

FIG. 1 schematically illustrates the construction of a model (configured to be used in an algorithm for aiding a maintenance decision) by an assistance device, according to one embodiment of the invention;

FIG. 2 schematically illustrates the entry analysis sub-block, contained in the assistance device from FIG. 1, in one embodiment of the invention;

FIG. 3 schematically illustrates the response analysis sub-block, contained in the assistance device from FIG. 1, in one embodiment of the invention;

FIG. 4 schematically illustrates an algorithm for constructing a model (configured to be used in an algorithm for aiding a maintenance decision), according to one embodiment of the invention;

FIG. 5 schematically illustrates the provision of aid for a maintenance decision, by the assistance device from FIG. 1, according to one embodiment of the invention;

FIG. 6 schematically illustrates an algorithm for aiding a maintenance decision (using the abovementioned model), according to one embodiment of the invention;

FIG. 7 schematically illustrates one example of a human-machine interface implemented by the maintenance device when executing the algorithm for aiding a maintenance decision from FIG. 6, in one embodiment of the invention;

FIG. 8 schematically illustrates one example of a hardware architecture of the assistance device from FIG. 1, according to one embodiment of the invention; and

FIG. 9 schematically illustrates one example of an aircraft maintenance algorithm (using the abovementioned aiding algorithm).

### DETAILED DESCRIPTION OF EMBODIMENTS

The detailed description below focuses on describing the proposed solution in the context of aircraft maintenance. As already mentioned above, the proposed solution is not limited to this particular context, and is also applicable to the maintenance of many other apparatuses (vehicles, machines, devices, equipment, etc.) for which there is a logbook containing entries (recording technical failures detected on the apparatus) and corresponding responses (recording maintenance procedures that made it possible to address these failures).

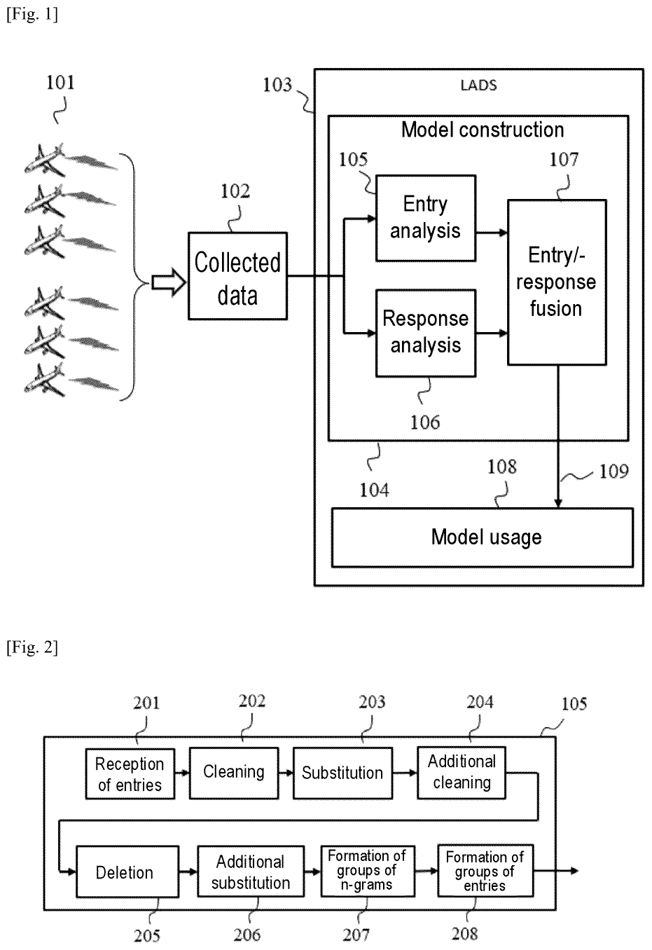

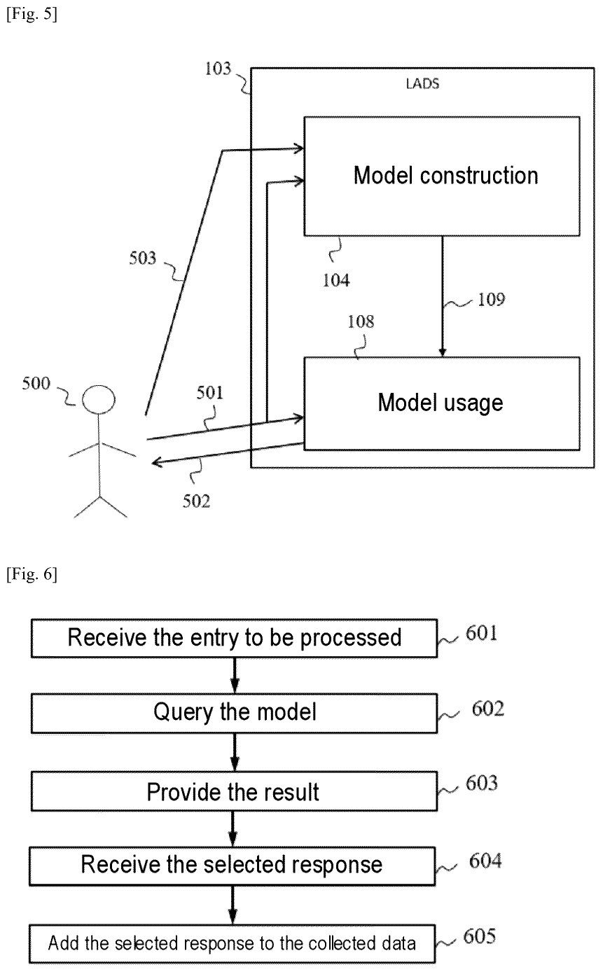

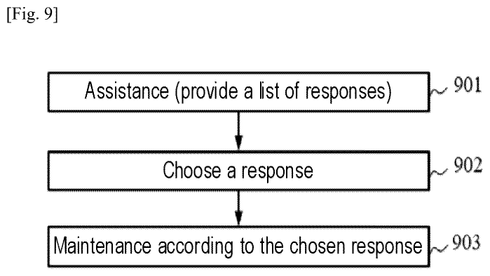

The presentation below is broken down as follows: the construction of a model by an assistance device is presented in relation to FIGS. 1 to 4; the use of this model, in an aiding algorithm executed by an assistance device, is presented in relation to FIGS. 5 to 7; the hardware architecture of this assistance device is presented in relation to FIG. 8; and a maintenance algorithm using this aiding algorithm is presented in relation to FIG. 9.

FIG. 1 schematically illustrates the construction of a model 109 by an assistance device 103, according to one embodiment of the invention. As detailed below, this model is configured to be used in an algorithm for aiding a maintenance decision in relation to an aircraft on which a technical failure is detected and entered in a logbook of the aircraft.

The assistance device 103 (also called LADS for “Logbook Answer Decision Support”) receives data 102 collected in logbooks of a fleet of aircraft 101. The collected data 102 comprise entries and associated responses. Each entry relates to a given technical failure detected on one of the aircraft of the fleet of aircraft 101, and is associated with a response indicating a maintenance procedure that made it possible to address the given technical failure.

The assistance device 103 comprises two main functional blocks: a model construction block 104 (which will now be described in greater detail) and a model usage block 108 (which is described below in relation to FIGS. 5 to 7).

The model construction block 104 comprises the following functional sub-blocks: an entry analysis sub-block 105, a response analysis sub-block 106 and an entry and response fusion sub-block 107 (after said entries and responses have been analysed by the sub-blocks 105 and 106, respectively), supplying the model 109 to the model usage block 108.

FIG. 4 schematically illustrates an algorithm for constructing the model, according to one embodiment of the invention. This algorithm is executed by the assistance device 103 from FIG. 1, and more precisely by the model construction block 104.

In a step 401, the assistance device receives the collected data 102, comprising entries and responses.

In a step 402, the assistance device forms groups of entries from the entries contained in the collected data. The criterion for forming the groups of entries is that entries in one and the same group have a common meaning in terms of describing a technical failure.

In a step 403, the assistance device associates, with each group of entries, a list of responses that is generated from the responses associated with the entries in this group of entries.

In a step 404, the assistance device learns to provide a result when the model is queried with a given entry to be processed. This result comprises a list of responses that is associated with a group of entries that is selected from the plurality of groups of entries. The selected group of entries is the one comprising entries having a meaning that is identical or similar, in terms of describing a technical failure, to the meaning of the given entry to be processed.

FIG. 2 schematically illustrates the entry analysis sub-block 105, contained in the assistance device 103 from FIG. 1 (and more precisely in the model construction block 104), in one embodiment of the invention. The entry analysis sub-block 105 itself comprises functional sub-blocks, referenced 201 to 208 and described below.

The sub-block 201 (also called “Reception of entries”) receives the entries (logbook entries) contained in the collected data 102.

The sub-block 202 (also called “Cleaning”) cleans the received entries. This cleaning comprises standardizing the entries in the logbooks of the aircraft of the fleet 101, for example using a standard natural language processing (NLP) process, which makes it possible in particular to correct typing errors, acronyms and produce a clear text therefrom.

The sub-block 203 (also called “Substitution”) homogenizes the vocabulary used in the entries, according to the specific features of a certain type of aircraft (for example the A350). For example, if the aircraft element “spoiler” is designated by various terms in the various entries (for example “splr” and “splrs”), only one term is retained. For example, if the term “splr” is retained, all of the terms “splrs” are replaced by “splr”.

The sub-block 204 (also called “Additional cleaning”) performs additional cleaning of the entries, in order to delete (filter) entries the associated responses of which are considered to have ultimately been inconclusive. In one embodiment, the execution of the sub-block 204 uses the judgement and/or knowledge of the aircraft manufacturer (for example of members of the engineering department and/or customer support department).

The sub-block 205 (also called “Deletion”) deletes irrelevant data from the wording of the entries.

The sub-block 206 (also called “Additional substitution”) searches for synonymous terms in the entries, so as to retain only one of these synonymous terms in the entries in question.

The sub-block 207 (also called “Formation of groups of n-grams”) forms groups (clusters) of n-grams (sets of successive words) contained in the entries. For this purpose, the sequence of words and the distances between words are studied, and when a resemblance in a sequence and frequency of words is identified, a new group of n-grams is formed or else an n-gram is added to an existing group of n-grams.

The sub-block 208 (also called “Formation of groups of entries”) forms groups (clusters) of entries, based on the groups (clusters) of n-grams formed by the sub-block 207. Each group of entries contains entries having a common meaning in terms of describing a technical failure. The sub-block 208 uses for example an artificial intelligence (AI).

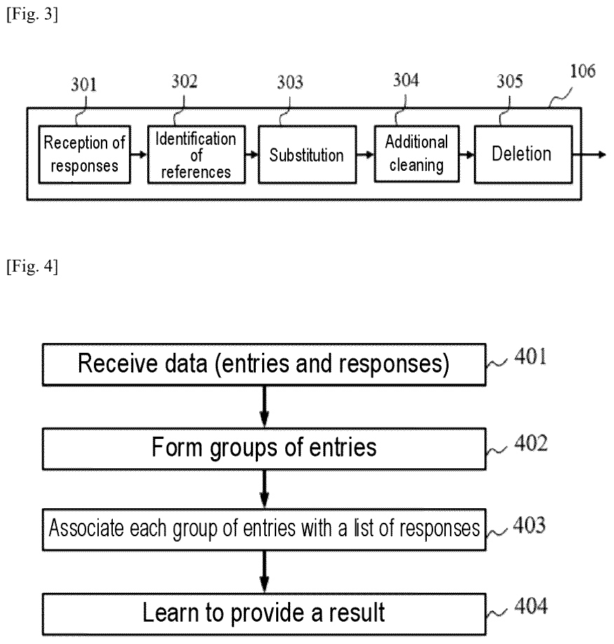

FIG. 3 schematically illustrates the response analysis sub-block 106, contained in the assistance device 103 from FIG. 1 (and more precisely in the model construction block 104), in one embodiment of the invention. The response analysis sub-block 106 itself comprises functional sub-blocks, referenced 301 to 305 and described below.

The sub-block 301 (also called “Reception of responses”) receives the responses (logbook responses) contained in the collected data 102.

The sub-block 302 (also called “Identification of references”) identifies AMM references and MMEL references contained in the responses received, and retains only responses containing an AMM reference or an MMEL reference. AMM (aircraft maintenance manual) references are references mentioned in the aircraft maintenance manual. MMEL (master minimum equipment list) references are references mentioned in a master minimum equipment list.

The sub-block 303 (also called “Substitution”) homogenizes the vocabulary used in the responses, according to the specific features of a certain type of aircraft (for example the A350).

The sub-block 304 (also called “Additional cleaning”) performs additional cleaning of the responses, in order to delete responses considered to have ultimately been inconclusive. In one embodiment, the execution of the sub-block 304 (like for the sub-block 204) uses the judgement and/or knowledge of the aircraft manufacturer (for example of members of the engineering department and/or customer support department).

The sub-block 305 (also called “Deletion”) deletes irrelevant data from the wording of the responses, so as to retain only standardized wording of AMM references (for example the first six digits) or MMEL references. For example, a maintenance operator, when providing information about their repair procedure, may insert information that does not contribute anything in terms of the repair itself (for example, “I put pins on and then I removed them”: it is well known that the operator will remove them, so it is not necessary to indicate this). This information, which is not related to the repair itself, is deleted so as to retain only information relating to essential maintenance actions.

Thus, picking up on the description of FIG. 1, the sub-block 107 (entry and response fusion) receives the groups (clusters) of entries provided by the entry analysis sub-block 105, on the one hand, and the processed responses (comprising only AMM references or MMEL references) provided by the response analysis sub-block 106, on the other hand. From all these received elements, the sub-block 107 generates the model 109 and provides it to the model usage block 108. In the model, as already mentioned above, each group of entries is associated with a list of responses that is generated from the responses associated with the entries in this group of entries. Moreover, the model is configured to learn to provide a result when it is queried with a given entry to be processed. This result comprises a list of responses that is associated with a group of entries that is selected from the plurality of groups of entries. The selected group of entries is the one comprising entries having a meaning that is identical or similar, in terms of describing a technical failure, to the meaning of the given entry to be processed.

FIG. 5 schematically illustrates the provision of aid for a maintenance decision, by the assistance device 103 from FIG. 1, according to one embodiment of the invention using the abovementioned model 109. In summary, a user 500 queries the assistance device 103 with an entry 501 to be processed and, in return, the assistance device 103, and more precisely the block 108, uses the model 109 to provide a result 502 (list of responses that is associated with a selected group of entries) to the user. Moreover, in one embodiment, the response 503 selected by the user is provided, with the entry 501 to be processed, to the model construction block 104, in order to enrich the model.

Many types of user are able to benefit from the proposed solution, in particular, but not exclusively:
a maintenance operator;
a crew member of the aircraft;
a member of a continuing airworthiness management organization (CAMO);
a member of an approved maintenance organization (AMO):
   a member of a customer services department of an aircraft manufacturer;
   a member of an engineering department of an aircraft manufacturer;
   a member of an aircraft troubleshooting manual (TSM) monitoring and update department;
   a member of an aircraft maintenance control centre (MCC);
   a member of an electronic logbook provider;
   etc.

More precisely, FIG. 6 schematically illustrates an algorithm for aiding a maintenance decision (using the abovementioned model), according to one embodiment of the invention. This algorithm is executed by the assistance device 103 from FIG. 1.

In a step 601, the assistance device receives the entry 501 to be processed, via a human-machine interface.

In a step 602, the assistance device queries the model with the entry to be processed, so that the model selects a group of entries (the one comprising entries having a meaning that is identical or similar, in terms of describing a technical failure, to the meaning of the entry to be processed) and provides a result comprising the list of responses that is associated with this selected group of entries.

In a step 603, the assistance device provides the result to the user via the abovementioned human-machine interface.

In a step 604, the assistance device receives the response 503 selected by the user from the list of responses that is associated with the selected group of entries.

In a step 605, the assistance device adds the selected response 503 to the data collected and processed by the model, associating the selected response 503 with the entry 501 to be processed.

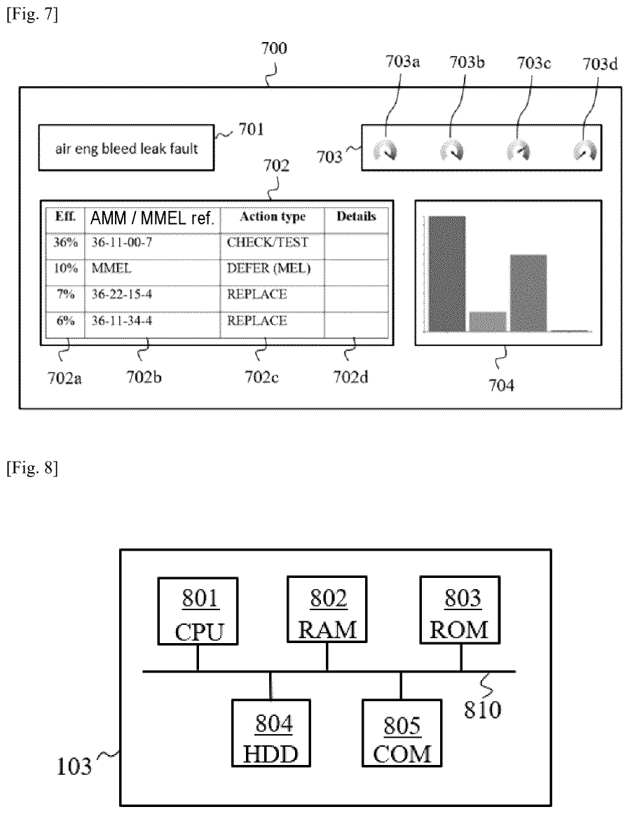

FIG. 7 schematically illustrates one example of a human-machine interface 700 implemented by the maintenance device 103 when executing the algorithm for aiding a maintenance decision from FIG. 6, in one embodiment of the invention.

The human-machine interface 700 is in this example an interface displayed on a display screen and comprising an input field 701 and three result fields 702, 703 and 704.

The input field 701 allows the user 500 to input an entry to be processed. In the example illustrated, the entry to be processed that has been input is “air eng bleed leak fault”, indicating a leak in the pneumatic system of the aircraft's engine.

The first result field 702 makes it possible to display the list of responses that is associated with the group of entries that is selected by the model. In the example illustrated, the list is in the form of a table comprising:
a first column 702a entitled “Eff.” and containing effectiveness information expressed as a percentage;
a second column 702b entitled “AMM/MMEL ref.” and containing a response in the form of an AMM reference or an MMEL reference;
a third column 702c entitled “Action type” and containing a type of response; and
a fourth column 702d entitled “Details” and containing additional information relating to the response in question.

Each row of this table therefore details a response in the list. For example, the first response in the list is the AMM reference “36-11-00-7”, which is associated with effectiveness information of 36% and an action type “Check/Test”.

In the example illustrated, corresponding to one particular embodiment, the responses in the list are sorted according to the effectiveness information 702a associated with these responses. The four responses are thus associated with effectiveness information of 36%, 10%, 7% and 6%, respectively.

In one embodiment, the effectiveness information 702a associated with a given response 702b depends on at least one of the following two parameters: a number of occurrences of the given response in the data collected by the model; and a period of time for which no new occurrences of the given response appear in the data collected by the model.

In one variant (not illustrated), the list of responses that is associated with the selected group of entries comprises:
a first sub-list, referred to as a repair sub-list, containing responses that each made it possible to avoid any new occurrence of the associated entry at least for a predetermined reference period; and
a second sub-list, referred to as a release sub-list, containing responses that each made it possible to avoid any new occurrence of the associated entry only for a period shorter than the predetermined reference period.

The second result field 703 makes it possible to display one or more possible operational impact indicators. In the example illustrated, corresponding to one particular embodiment, the following four indicators are displayed:
an aircraft delay above a predetermined threshold (for example 15 minutes) indicator 703a (also called “Delay+15′”);
an aircraft flight cancellation indicator 703b (also called “Cancel”);
an aircraft returning to point of departure indicator 703c (also called “IFTB” for “In-Flight Turn Back”); and
an aircraft change of destination indicator 703d (also called “Diversion”).

In one embodiment, each of the possible operational impact indicators (703a to 703d) has a value that depends on possible operational impact values obtained beforehand for at least some of the responses in the list of responses that is associated with the selected group of entries.

Thus, in the case where the user is a maintenance operator, the human-machine interface 700 suggests to them a list of possible responses (maintenance procedures) to the problem defined by the entry to be processed (logbook entry), with, for each possible response, its effectiveness information (702a) and its operational impact (703a to 703d). The user therefore has an aid (or support) for deciding which response to adopt. Once the response (maintenance procedure) has been chosen and the repair actions have been carried out, the user may input them in the aircraft logbook, which is transmitted to the assistance device 103 so as to be taken into account.

FIG. 8 schematically illustrates one example of a hardware architecture of the assistance device 103 from FIG. 1, according to one embodiment of the invention. The assistance device 103 comprises the following, connected by a communication bus 810: a processor or CPU (central processing unit) 801; a random access memory (RAM) 802; a read-only memory (ROM) 803, for example a flash memory; a data storage device, such as a hard disk drive (HDD), or a storage medium reader, such as a Secure Digital (SD) card reader 804; at least one communication interface 805 enabling the assistance device 103 in particular to receive the data 102 collected in logbooks of the fleet of aircraft 101 (see FIG. 1) and to interact with the user 500 (see FIG. 5).

The processor 801 is capable of executing instructions loaded into the RAM 802 from the ROM 803, from an external memory (not shown), from a storage medium, such as an SD card, or from a communication network (not shown). When the assistance device 103 is powered on, the processor 801 is capable of reading instructions from the RAM 802 and of executing them. These instructions form a computer program that causes the processor 801 to implement the behaviours, steps and algorithm described here (see the description of FIGS. 1 to 7 above), in particular to implement the two main functional blocks 104 (model construction block) and 108 (model usage block).

All or some of the behaviours, steps and algorithm described here may thus be implemented in software form by executing a set of instructions using a programmable machine, such as a digital signal processor (DSP) or a microcontroller, or be implemented in hardware form by a machine or a dedicated component (chip) or a dedicated set of components (chipset), such as a field-programmable gate array (FPGA) or an application-specific integrated circuit (ASIC). Generally speaking, the assistance device 103 comprises electronic circuitry designed and configured to implement the behaviours, steps and algorithms described here, in particular the implementation of the two main functional blocks 104 and 108.

In one variant, the model construction block 104 and the model usage block 108 are contained in two separate computing devices (each having, in one embodiment, the hardware architecture detailed in FIG. 8). In this variant, the computing device implementing the model usage block 108 may have a computing power much lower than that of the computing device implementing the model construction block 104. This is because constructing the model requires much greater computing power than using the model. Another advantage of this variant is that the computing device implementing the model construction block 104 is able to cooperate with (that is to say provide the constructed model to) a plurality of computing devices each implementing the model usage block 108.

The solution offers numerous advantages, both for airlines and for aircraft manufacturers.

For example, for airlines:
the ability to ascertain possible operational impacts directly, from each entry in the logbook; and
the ability to ascertain the reference of the maintenance procedure to address these directly, from each entry in the logbook: repair procedure defined by an AMM reference (for example up to 6 digits) or MMEL procedure to respond to the logbook entry and thus release the aircraft without using the lengthy and theoretically constructed list of TSM tasks (thus, during the turnaround time (TAT), any member of an AMO or CAMO, any mechanic or any member of an MCC may immediately obtain a relevant AMM or MMEL reference to be applied and thus save a great deal of time).

For example, for aircraft manufacturers:
the ability to verify and improve the TSM based on effective in-service information feedback;
the ability to offer a service to airlines; and
the possibility of offering electronic logbook (eLogbook) providers a means of authorizing natural-language inputting of the entry into the logbook.

FIG. 9 schematically illustrates one example of an aircraft maintenance algorithm (using the abovementioned aiding algorithm). It will be assumed that a technical failure has been detected on the aircraft and is entered in the aircraft logbook, the resulting entry being referred to as an entry to be processed.

In a step 901, the assistance device 103 executes the algorithm for aiding a maintenance decision, in one of the embodiments described above (see the description of FIGS. 5 to 7). As a reminder, this aiding algorithm receives the entry to be processed and provides a user with a result comprising a list of responses that is associated with a group of entries that is selected according to the entry to be processed.

In a step 902, the user chooses a response from the list of responses.

In a step 903, the maintenance procedure indicated in the chosen response is carried out, by the user or else automatically or semi-automatically.

1. A method, implemented by an assistance device comprising electronic circuitry, for aiding a maintenance decision in relation to an apparatus on which a technical failure is detected and entered, as an entry to be processed, in a logbook of the apparatus, the method comprising:
receiving the entry to be processed;
querying, with the entry to be processed, a model that is configured to provide, when it is queried with a given entry, a result comprising a list of responses that is associated with a group of entries that is selected from a plurality of groups of entries, each group of entries being formed from entries contained in collected data and having a common meaning in terms of describing a technical failure, each group of entries being associated with a list of responses that is generated from the responses associated with the entries in said group of entries, the selected group of entries comprising entries having a meaning that is identical or similar, in terms of describing a technical failure, to the meaning of the given entry, the collected data originating from logbooks of a fleet of apparatuses and comprising entries relating to technical failures detected on the apparatuses of the fleet and associated responses indicating the maintenance procedures that made it possible to address said technical failures; and
providing a user with the result of querying the model with the entry to be processed, the result comprising the list of responses that is associated with the group of entries that is selected by the model according to the entry to be processed.

2. The method according to claim 1, wherein the apparatus is an aircraft.

3. The method according to claim 2, wherein the list of responses that is associated with the selected group of entries comprises references belonging to the group comprising:
aircraft maintenance manual references, referred to as AMM references; and
master minimum equipment list references, referred to as MMEL references.

4. The method according to claim 1, wherein each of the responses contained in the list of responses that is associated with the selected group of entries is associated with effectiveness information.

5. The method according to claim 4, wherein the response contained in the list of responses that is associated with the selected group of entries are sorted according to the effectiveness information associated with said responses.

6. The method according to claim 4, wherein the effectiveness information associated with a given response depends on at least one parameter belonging to the group comprising:
a number of occurrences of the given response in the data collected by the model; and
a period of time for which no new occurrence of the given response appears in the data collected by the model.

7. The method according to claim 1, wherein the list of responses that is associated with the selected group of entries comprises:
a first sub-list, referred to as a repair sub-list, containing responses that each made it possible to avoid any new occurrence of the associated entry at least for a predetermined reference period; and
a second sub-list, referred to as a release sub-list, containing responses that each made it possible to avoid any new occurrence of the associated entry only for a period shorter than the predetermined reference period.

8. The method according to claim 1, wherein the result of querying the model with the entry to be processed furthermore comprises at least one possible operational impact indicator.

9. The method according to claim 2, wherein said at least one possible operational impact indicator belongs to the group comprising:
an aircraft delay above a predetermined threshold indicator;
an aircraft flight cancellation indicator;
an aircraft returning to point of departure indicator; and
an aircraft change of destination indicator.

10. The method according to claim 8, wherein said at least one possible operational impact indicator has a value that depends on possible operational impact values obtained beforehand for at least some of the responses in the list of responses that is associated with the selected group of entries.

11. The method according to claim 1, furthermore comprising:
receiving a response selected by the user from the list of responses that is associated with the selected group of entries; and
adding the selected response to the data collected and processed by the model, associating the selected response with the entry to be processed.

12. (canceled)

13. A non-transitory storage medium storing a computer program comprising instructions that cause a processor to carry out the method according to claim 1 when said instructions are read and executed by the processor.

14. An assistance device comprising electronic circuitry configured to implement the method according to claim 1.

15. A computer-implemented method for constructing a model configured to be used in a method, according to claim 1, for aiding a maintenance decision in relation to an apparatus on which a technical failure is detected and entered in a logbook of the apparatus, the resulting entry being referred to as an entry to be processed, the method for constructing the model comprising:
receiving data collected in logbooks of a fleet of apparatuses and comprising entries and associated responses, each entry relating to a given technical failure detected on one of the apparatuses of the fleet of apparatuses, and being associated with a response indicating a maintenance procedure that made it possible to address the given technical failure;
forming groups of entries from the entries contained in the collected data, entries in one and the same group having a common meaning in terms of describing a technical failure;
associating, with each group of entries, a list of responses that is generated from the responses associated with the entries in said group of entries; and
learning to provide, when the model is queried with a given entry to be processed, a result comprising a list of responses that is associated with a group of entries that is selected from the plurality of groups of entries, the selected group of entries comprising entries having a meaning that is identical or similar, in terms of describing a technical failure, to the meaning of the given entry to be processed.

16. A method for maintaining an apparatus on which a technical failure is detected and entered in a logbook of the apparatus, the resulting entry being referred to as an entry to be processed, the maintenance method comprising:
carrying out the method for aiding a maintenance decision according to claim 1, the aiding method receiving the entry to be processed and providing a result comprising a list of responses that is associated with a group of entries that is selected according to the entry to be processed;
choosing a response from the list of responses; and
carrying out a maintenance procedure indicated in the chosen response.
